(19) United States
(12) Patent Application Publication
(10) Pub. No.: US 2024/0066999 A1
(43) Pub. Date: Feb. 29, 2024

(54) Braking of an Electrically Driven Vehicle

(71) Applicant: KNORR-BREMSE Systeme fuer Nutzfahrzeuge GmbH, Muenchen (DE)

(72) Inventors: Daniel GEIS-ESSER, Muenchen (DE); Martin MEDERER, Neumarkt (DE); Jochen RETTER, Holzgerlingen (DE); Sven KRUEGER, Muenchen (DE); Tobias SCHOEFBERGER, Mainburg (DE); Dietmar TISSEN, Duesseldorf (DE)

(21) Appl. No.: 18/269,988

(22) PCT Filed: Jan. 5, 2022
(86) PCT No.: PCT/EP2022/050169

§ 371 Date: Jun. 28, 2023

(30) Foreign Application Priority Data
Feb. 5, 2021 (DE) 10 2021 201 113.6

(51) Int. Cl. B60L 15/20; B60L 7/18

(52) U.S. Cl. CPC B60L 15/2009; B60L 7/18; B60L 2200/28; B60L 2240/427

(57) ABSTRACT

A method for braking a vehicle driven by an electric driving engine is disclosed, wherein the braking is at least partially performed by the driving engine. The method includes generating a generator output by the driving engine by driving the driving engine in overrun mode by the vehicle, increasing a first voltage level, at which the driving engine is operated, to adjust the generator output to an amount required for the braking, and providing the generator output adjusted to the required amount.

### BACKGROUND AND SUMMARY

The present invention relates to a method for braking an electrically driven vehicle as well as a device and a vehicle for performing the method. Additionally, the invention relates to a computer program product and a storage medium for performing or passing on the method.

During operation of electrically driven vehicles the possibility arises to replace or supplement technology for braking force generation known from conventionally driven vehicles partially, at best completely, by the generator operation of the electric driving engine. The limiting factor here is the machine current, which thermally stresses the traction machine.

Particularly, permanent brake devices, such as retarder, have to be mentioned here. A permanent brake device is particularly used in a permanent brake case, in which it has to be ensured that the vehicle has a specific braking power available for a longer period of time to, for example, not exceed a prescribed maximum speed on a slope.

Moreover, service brake devices, which are, for example, friction based and preferably comprise disc brakes and/or drum brakes, have to be mentioned as further brake technology. A service brake device is particularly used in a service brake case, which does not require the provision of braking power for a longer period of time, but instead for a comparatively short period of time. This is, for example, an emergency braking or a braking to stop the vehicle or to adjust the speed accordingly. The maximum braking power retrieved in the service brake case may exceed the one in the permanent brake case.

Additionally, contactless brakes such as eddy current brakes have to be mentioned for both the permanent and also the service brake case.

It is known that a braking effect on the vehicle via the drive train can be caused by the generator operation of the electric driving engine. A typical application is the recuperation of energy during the overrun mode of the vehicle. However, the braking effect generated thereby is not sufficient in any situation, particularly at high vehicle speed.

Accordingly, it is an objective of the present invention to show a possibility to increase the braking effect or the braking power, respectively, by the electric driving engine.

This objective is solved by the subject matters of the independent claims. Advantageous modifications are subject to the dependent claims.

According to the invention, a method for braking a vehicle driven by an electric driving engine is provided, wherein the braking is at least partially performed by the driving engine. The vehicle may also comprise more than one electric driving engine, wherein several electric driving engines may then also be applied when braking.

The method comprises the following steps:
step A: Generating a generator output by the driving engine by driving the driving engine in overrun mode by the vehicle;
step B: Increasing a first voltage level, at which the driving engine is operated, to adjust the generator output to an amount required for the braking; and
step C: Providing the generator output adjusted to the required amount.

Preferably, the machine current of the driving engine is lowered in step B, wherein the generator output is thereby adjusted to an amount required for the braking.

For example, the inverter input voltage, also referred to as intermediate circuit voltage, is increased. As a result, a higher motor terminal voltage may be set at the driving engine. This entails, that the machine current decreases for the same generator output.

The sequence of steps A to C is not determined by the sequence of letters used. In particular, steps A and B may also be carried out simultaneously here. It is also conceivable to execute step B already before step A in order to already initiate the braking at the voltage level required therefor.

Preferred modifications of the invention are described below.

Preferably, a lowering of the current in the driving engine occurs by the increase of the first voltage level according to step B compared to an operating state without an increase of the first voltage level according to step B. Thus, it is advantageously achieved that the identical generator output at lower current is achieved. In this way, the thermal load of the driving engine may be particularly decreased.

Preferably, step B for adjusting the generator output comprises an increase of the current in the driving engine. Alternatively, the current in the driving engine remains the same compared to an operating state without an increase of the first voltage level according to step B. In this way, an increase of the generator output of the driving engine may be achieved. Thereby, the current has to be increased less compared to an operating state without an increase of the first voltage level. The generator output is also increased by the voltage increase at a constant current.

Preferably, the current in the driving engine is kept within predetermined limits, preferably within thermally admissible limits. Such limits may be particularly defined by the amount of the admissible current and/or by a specification of a specific maximum admissible current level over time.

Alternatively or in addition, a method step is provided, in which a monitoring of the driving engine with respect to its, particularly thermal, load is performed. Such a monitoring may also comprise to take countermeasures, such as, for example, a further increase of the first voltage level in step B, to further lower the current and to keep the generator output the same or to increase it.

In general, step B may comprise a further increase of the voltage levels, in particular of the first voltage level, preferably in addition to the first increase of the first voltage level.

Preferably, the braking relates to a permanent brake case or a service brake case.

Preferably, the braking by the driving engine complements further systems present in the vehicle, in particular a permanent brake system, preferably as described above, particularly comprising a retarder, and/or a service brake system, preferably as described above, particularly comprising a friction brake. Alternatively or in addition, braking systems, which operate contactless, such as an eddy current brake, may also be complemented by the braking by the driving engine. Advantageously, this results in the fact that the existing systems may be dimensioned smaller. A conventional retarder does no longer have to provide the entire braking power but it may be supplemented by the braking by the driving engine, which in turn save costs.

Preferably, the generator output provided in step C is at least partially supplied to an energy storage of the vehicle. By this, an electric energy storage, such as a battery, particularly a traction battery, may be considered. Nevertheless, other energy storages such as a capacitor are also conceivable.

Preferably, a second voltage level is provided, which is not increased, wherein the energy storage is operated at the second voltage level. In this way, a protection of the energy storage may be achieved. More preferably, an active separation of the energy storage from the first voltage level is carried out. Thus, the energy storage is not stressed by the first voltage level. An isolating transducer or a mechanical separation by a contactor may be particularly provided to separate the energy storage from the first voltage level.

The second voltage level is preferably specified by the energy storage.

The use of an isolating transducer results in the advantage that the first voltage level may be set in both the driving and the braking operation such that the driving engine is operated at an optimal voltage level, whereby a driving as well as braking power as high as possible may be achieved.

Preferably, the first voltage level and the second voltage level provide the same voltage before performing step B.

Preferably, the generator output provided in step C is at least partially supplied to at least one electric consumer of the vehicle, in particular a resistor. The at least one consumer is more preferably operated at the first voltage level. For example, the at least one electric consumer may be configured as braking resistor or may comprise a braking resistor, which converts the generator output conducted through it into heat.

Preferably, an inverter of the vehicle is also operated at the first voltage level.

Preferably, the generator output is at least partially supplied to the at least one electric consumer, in particular the resistor, in dependence on the actual energy intake capacity of the energy storage, wherein particularly no supply of generator output to the energy storage is carried out when the energy storage is full. If the energy storage is not capable of storing further generator output, the generator output is preferably entirely guided via the at least one consumer, particularly via the resistor. More preferably, the generator output is entirely supplied to the at least one consumer, in particular the resistor, when the energy storage is full or separated from the power supply.

Preferably, the generator output is at least partially supplied to the energy storage in dependence on the actual energy intake capacity of the energy storage. Here, a stepwise supply may be carried out. Especially with low energy intake capacity, i.e. when the energy storage is relatively full, preferably little generator output is supplied to the energy storage, wherein with high energy intake capacity, i.e. when the energy storage is relatively empty, preferably more generator output is supplied to the energy storage.

More preferably, the generator output is entirely supplied to the energy storage and/or resistor.

Preferably, the vehicle is configured to be not track-bound or overhead wire-bound.

In particular, the vehicle is configured as commercial vehicle, tractor, trailer or truck.

As another aspect of the invention, a device for performing the method described above is provided, wherein the device comprises an interface for influencing the level of the first voltage level, at which an electric driving device is operated, wherein the device comprises a data processing unit configured to perform the method described above. The data processing unit comprises preferably electronic processing means configured to perform the method, wherein the data processing unit further provides respective control signals via the interface, in particular a data or bus interface, to influence the level of the first voltage level. More preferably, the device is configured as drive control device and/or brake control device.

As another aspect of the invention, a vehicle for performing the method described above is provided, wherein the vehicle comprises a device described above, and/or wherein the vehicle is configured to perform the method described above. The vehicle is preferably not track-bound or overhead wire-bound. In particular, the vehicle is configured as commercial vehicle, tractor, trailer or truck.

The above-described device and the above-described vehicle preferably comprise individual features listed in the above description of the method which relate to the device or vehicle.

As another aspect of the invention, a computer program product having code means, which, when being executed on a data processing unit, cause it to execute the method described above, is provided. The data processing unit is preferably the one provided in the above-described device. Thus, also an existing device, such as a drive control device or a brake control device, may be adapted to perform the method described above.

As another aspect of the invention, a storage medium for being read by a data processing unit is provided, wherein the storage medium comprises a computer program product as described above. Thereby, the invention may be passed on. The storage medium preferably comprises an USB stick, a memory card and/or a CD-ROM.

The invention is not limited to the embodiments described above. Rather, by combining, omitting and/or exchanging individual features, further subject matters may be formed, which also fall within the claimed scope of protection. For example, a combination is conceivable, in which the at least one consumer, in particular the resistor, and the energy storage are applied in combination to enable a distribution of the generator output on the consumer and energy storage.

The following is a description of preferred embodiments of the invention with reference to the accompanying drawings.

### BRIEF DESCRIPTION OF THE DRAWINGS

FIG. 1 is a first embodiment of the invention;

FIG. 2 is a modification of the embodiment shown in FIG. 1;

FIG. 3 is a modification of the embodiment shown in FIG. 1; and

FIG. 4 is a combination of the embodiments shown in FIG. 2 and FIG. 3.

### DETAILED DESCRIPTION OF THE DRAWINGS

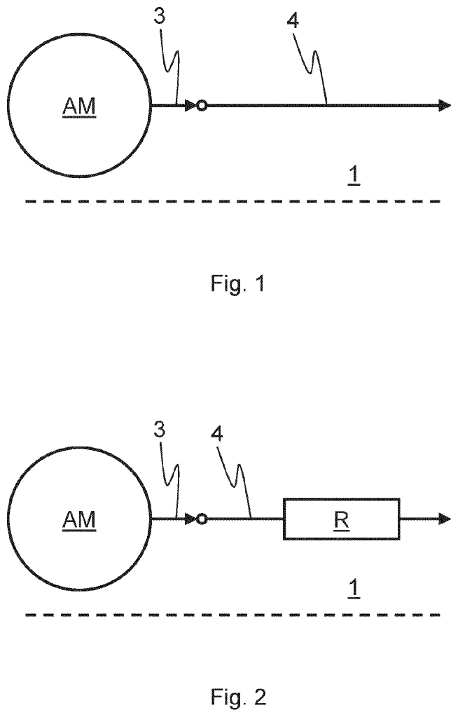

FIG. 1 shows a first embodiment of the invention.

An electric driving engine AM of a vehicle is shown, which generates or delivers, respectively, a generator output 3 or a recuperation power, respectively, in the overrun mode or generator operation, respectively. This is provided via a first power path 4, wherein the generator operation results in a braking effect on the vehicle via the drive train.

Thereby, the braking effect may be used in a permanent brake case, in particular on a slope, or in a service brake case, in particular for an emergency braking or a speed reduction up to a stop braking. An application may be in particular the substitute of the friction brake.

The driving engine AM is operated at the first voltage level 1.

If the vehicle is to be driven, this may be carried out by a driving power, which is provided by the driving engine AM. The driving engine AM may be provided in an electrically driven vehicle, which may be a solely electric vehicle with one or more driving engines AM, wherein one or more up to all driving engines AM may be used to perform the method. However, the method may also be used for hybrid vehicles, in which a driving engine AM is directly involved in driving the vehicle.

To increase the braking effect, the generator output 3 is increased. This increase is achieved by increasing the first voltage level 1. Compared to an operation of the driving engine AM without increase of the first voltage level 1, the current in the driving engine AM may here be lowered or kept constant to achieve the required generator output 3. The current may also be further increased, if the increase of the generator output 3 is still not sufficient, wherein this increase is less than without increase of the first voltage level 1.

Additionally, if a further increase of the generator output 3 to increase the braking effect is required, a further increase of the first voltage level 1 may be performed.

In any event, a thermal overload of the driving engine AM due to excessive currents may be avoided.

FIG. 2 shows a modification of the embodiment shown in FIG. 1.

Accordingly, only the differences to FIG. 1 will be discussed below. Otherwise, it is referred to the remarks on FIG. 1.

The embodiment according to FIG. 2 shows a possibility to use a resistor R as electric consumer to convert the generator output 3 into heat.

Here, the resistor R is configured as braking resistor and is also at the first voltage level 1 as the driving engine AM. Thus, an increase of the voltage is also achieved for the resistor R. The generator output 3 is provided to the resistor R via the first power path 4.

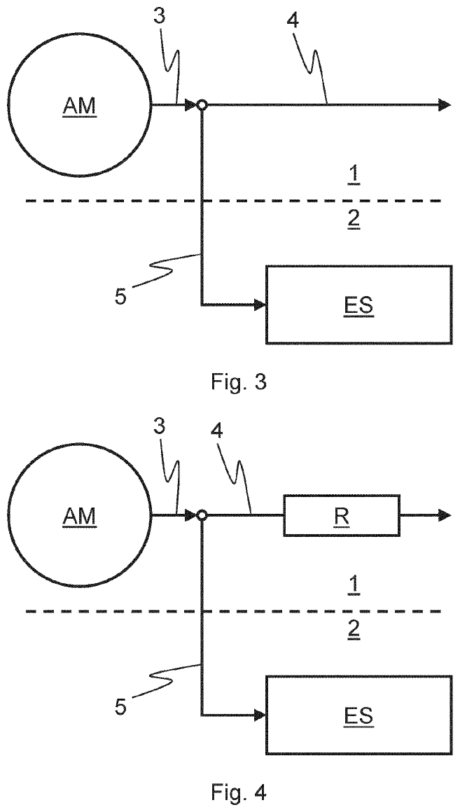

FIG. 3 shows a modification of the embodiment shown in FIG. 1.

Accordingly, only the differences to FIG. 1 will be discussed below. Otherwise, it is referred to the remarks on FIG. 1.

An energy storage ES is shown, which is supplied with the generator output 3 via a second power path 5. By this, an electric energy storage, such as a battery, in particular a traction battery, may be considered. Nevertheless, other energy storages, such as a capacitor (Cap), are also conceivable, which may also provide a combination of battery and capacitor.

The supply of the energy storage ES with the generator output 3 may be carried out partially or entirely. I.e. the generator output 3 may be entirely provided to the second power path 5 and therefore to the energy storage ES. However, a distribution of the generator output 3 on the first power path 4 and the second power path 5 may also be carried out. Eventually, it is also conceivable to exclusively supply the generator output 3 to the first power path 4. This is especially the case, if the actual intake capacity of the energy storage ES is reduced or is completely absent.

The energy storage ES is thereby operated at a second voltage level 2. In this way, it is possible to exclude the energy storage ES from the increase of the first voltage level 1. If the energy storage comprises a battery, the latter may be protected.

For example, it may be provided that an isolating transducer is provided, which realizes the distribution of the two voltage levels 1 and 2. Alternatively or in addition, a mechanical interruption by a contactor may therefore be provided such that the second voltage level 2 is also mechanically separated from the first voltage level 1.

FIG. 4 shows a combination of the embodiments shown in FIG. 2 and FIG. 3.

Accordingly, for the description of the individual components, it is referred to the above remarks on FIGS. 1 to 3.

In this embodiment, it is advantageous that the generator output 3, which cannot be supplied to the energy storage ES via the second power path 5, whether because it cannot accept or store, respectively, further energy or for other reasons, may instead be supplied to the resistor R via the first power path 4 to allow a braking by the driving engine AM at any time.

As application of each of the embodiments shown in FIGS. 1 to 4, another number-based embodiment is provided herein.

When driving downhill with 7% slope and constant vehicle speed, an increase of the first voltage level 1 from 725 V to 860 V at a constant generator output 3 or recuperation power, respectively, results in a lowering of the current of the electric driving engine AM from 186 A to 176 A. In this example, the electric driving engine AM is operated within the admissible load limits and, furthermore, protected by the lowering of the current.

### LIST OF REFERENCE SIGNS

1 first voltage level
2 second voltage level
3 generator output
4 first power path
5 second power path
AM driving engine
ES energy storage
R resistor

1-15. (canceled)

16. A method for braking a vehicle at least partially by an electric driving engine, the method comprising:
generating a generator output by driving an electric driving engine of a vehicle in an overrun mode;
adjusting the generator output to an amount required for braking the vehicle by increasing a first voltage level at which the electric driving engine is operating; and
providing the generator output adjusted to the required amount.

17. The method of claim 16, wherein increasing the first voltage level causes a lowering of current in the electric driving engine.

18. The method of claim 16, wherein adjusting the generator output comprises increasing a current in the electric driving engine.

19. The method of claim 16, wherein the generator output is adjusted without changing a current in the electric driving engine.

20. The method of claim 16, wherein current in the electric driving engine is kept within a predetermined limit.

21. The method of claim 20, wherein the predetermined limit comprises a thermally-admissible limit.

22. The method of claim 16, further comprising monitoring a thermal load of the electric driving engine.

23. The method of claim 16, wherein the generator output is at least partially supplied to an energy storage of the vehicle.

24. The method of claim 23, wherein the energy storage is operated at a second voltage level, and wherein the first voltage level and the second voltage level are the same before the generator output is adjusted.

25. The method of claim 16, wherein the generator output is at least partially supplied to at least one electric consumer of the vehicle.

26. The method of claim 25, wherein the at least one electric consumer of the vehicle comprises a braking resistor, and wherein the braking resistor is operated at the first voltage level.

27. The method of claim 16, wherein the generator output at least partially supplied to a braking resistor and depends on an actual energy intake capacity of an energy storage, such that no supply of generator output to the energy storage is carried out when the energy storage is full.

28. A vehicle comprising:
an electric driving engine; and
a data processing unit configured to:
cause the electric driving engine to operate in an overrun mode, which causes the electric driving engine to generate a generator output; and
adjust the generator output to an amount required for braking the vehicle by increasing a first voltage level at which the electric driving engine is operating.

29. The vehicle of claim 28, wherein the data processing unit is configured to provide the generator output adjusted to the required amount.

30. The vehicle of claim 28, wherein the braking is performed by a permanent brake.

31. The vehicle of claim 28, wherein the braking is performed by a service brake.

32. The vehicle of claim 28, wherein at least one other braking system is used in combination with the electric driving engine for braking the vehicle.

33. The vehicle of claim 32, wherein the at least one other braking system comprises a permanent brake system, a retarder, a service brake system, a friction brake, or an eddy current brake.

34. The vehicle of claim 28, wherein the vehicle comprises a commercial vehicle, tractor, trailer, or truck, and wherein the vehicle is not track-bound or overhead wire-bound.

35. A vehicle comprising:
an electric driving engine;
means for causing the electric driving engine to operate in an overrun mode, which causes the electric driving engine to generate a generator output; and
means for adjusting the generator output to an amount required for braking the vehicle by increasing a first voltage level at which the electric driving engine is operating.
